(19) United States
(12) Patent Application Publication
(10) Pub. No.: US 2010/0248721 A1
(43) Pub. Date: Sep. 30, 2010

(54) METHOD FOR ESTABLISHING A POINT TO POINT CALL A CALL SERVER AND COMMUNICATION SYSTEM FOR ESTABLISHING A POINT TO POINT CALL

(76) Inventor: Alain Janssoone, Saint Lambert des Bois (FR)

Correspondence Address: Pearl Cohen Zedek Latzer, LLP, 1500 Broadway, 12th Floor, New York, NY, 10036, US

(21) Appl. No.: 12/670,435

(22) PCT Filed: Jul. 18, 2008
(86) PCT No.: PCT/FR2008/001079

§ 371 Date: Jan. 25, 2010

(30) Foreign Application Priority Data
Jul. 25, 2007 (FR) 0705396

(51) Int. Cl. H04W 60/00

(52) U.S. Cl. 455/435.1

(57) ABSTRACT

The invention relates to a method for establishing a call between a first access point and a second access point, by means of a network for multipoint broadcasting. The method comprises a step for attribution (20) of a multipoint address to the call, a step for communication (30) of the multipoint address to the points of access and a step for registration (40) of the access points at the multipoint address. The access points subsequently send all the media data for the call to the multipoint address. The invention further relates to a call server and a mobile radiocommunication system which permits third parties to join conversations initiated between two parties. In particular, the invention relates to professional mobile radiocommunication systems.

The invention relates to a method for establishing a call that is initially point to point that may later change into a multipoint call. The invention also relates to a call server as well as a mobile radiocommunication system allowing third parties to subsequently intervene in or join calls initiated between two parties. In particular, the invention applies to professional mobile radiocommunication systems, such as defined by the Telecommunications Industry Association (TIA) for the Association of Public-Safety Communications Officers (APCO) or as defined by the European Telecommunications Standards Institute through the Terrestrial Trunked Radio (TETRA) standard, or even by industrial forums such as the TETRAPOL forum.

A mobile radiocommunication system comprises, first, a fixed infrastructure with a routing and processing system and, second, terminals. The fixed infrastructure is divided into cells, each covering a given geographic area. Each cell comprises one or more point(s) of access to the fixed infrastructure. The terminals may be mobile and/or portable radios, modems, personal assistants, recording devices, etc. Each terminal accesses the fixed infrastructure through at least one of the access points, itself particularly allowing data to be received and sent via the network to other terminals belonging to the network. An access point may be, in particular, a set of connection means within a determined geographic area. Connection means may be fixed, of the cable-controlled type for example, or even mobile, of the wireless air interface type, for example. Depending on the connection means, knowledge of the access point to which the terminal is connected may be acquired via:

### Replacement Sheet (Rule 26)

static means, such as for example, a table of administered routing giving the relationship between the address of a terminal and the address of an access point; or
dynamic means, such as for example, a mobility transaction initiated by a terminal joining the access point and making its location known in the network.

Thus, each access point, upon request for example by a terminal, has in particular the ability to request the establishment of a call to another access point. A call is described as a point to point call when the call is established between only two access points. A call is described as a multipoint call (or Talkgroup Call) when the call is established between at least three access points. Conference calls and group calls may be distinguished from among multipoint calls. During a call, flows of bidirectional media data are exchanged and routed to access points. These media data flows may be in particular audio data, visual data, data of an informative nature, messages, etc. These media data flows are, in particular, to be distinguished from signal data flows.

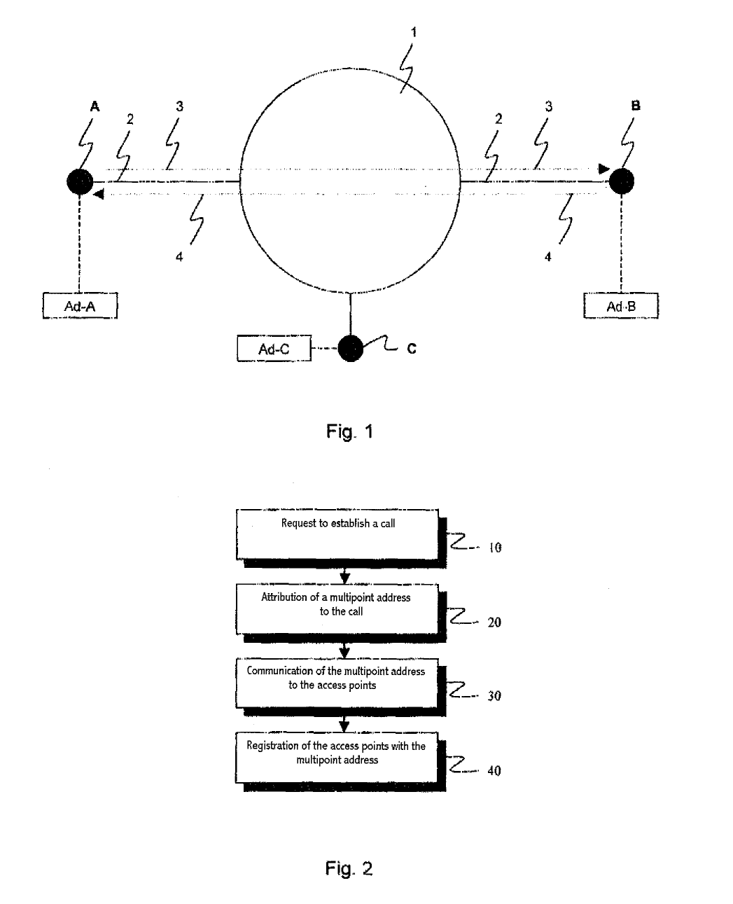

FIG. 1 illustrates, in a diagram, a mobile radiocommunication system according to the prior art. The system represented comprises a network 1 only supporting point to point connections (or unicast connections). Network 1 authorizes the establishment of point to point calls between terminals A, B and C. To establish a call 2 between, for example, terminal A and terminal B, the system according to the prior art creates, by using a signaling protocol, a first point to point session 3 from terminal A to terminal B, as well as a second point to point session 4 from terminal B to terminal A. An address Ad_A of the point to point type is associated with terminal A, while an address Ad_B of the point to point type is associated with terminal B. Throughout the first session 3, terminal B may receive media data flows sent by terminal A to address Ad_B. In addition, throughout the second session 4, terminal A may receive media data flows sent by terminal B to address Ad_A.

However, this solution turns out to be not very suitable to the case where a third terminal wishes to subsequently intervene in or join calls initiated between terminals A and B. More generally, the utilization of two point to point addresses Ad_A and Ad_B following the establishment of call 2 between terminal A and terminal B makes the participation or intervention of other terminals in this call 2 complex and cumbersome, especially in terms of signal and media data flow management. Such being the case, the change of a point to point call into a multipoint call is required in many use cases, some of which are specific and peculiar to the professional mobile radiocommunication system.

By way of example, terminal C may wish to join point to point call 2 initially established between terminal A and terminal B. Terminal C may be, for example, another terminal of the same type as terminal A and/or B (thus transforming a point to point call into a multipoint call), or even be a terminal fulfilling a third-party function, such as, for example, a device for recording and/or monitoring media data flows from call 2. The change of point to point call 2 into a multipoint call in a point to point network leads to a break in the media data flow, additional signaling effort and ad hoc network resources to select and broadcast media data flows to and from different point to point addresses.

In addition, when a terminal changes an access point, particularly when it changes a cell, it is desirable that the calls in progress are not interrupted (a function generally designated by the expression “Hand-over”). During this procedure, the media data flow corresponding to the call in progress must be sent to the access point managing the call in the cell where the terminal comes from and to the access point situated in the cell where the terminal is going. During this phase, the point to point call initially comprising two access points necessitates that media data flows be sent to a third access point. The migration of a point to point call into a multipoint call in a network ill-adapted to multipoint calls leads to a break in the flow of media data, additional signaling effort and ad hoc network resources to select and broadcast the flows of media data to and from different point to point addresses.

Methods for establishing initially multipoint calls exist in the prior art, particularly in the case of calls known as group calls. In the case of calls that are initially point to point, also described as individual calls, that may subsequently change into multipoint calls, solutions that only partially respond to the problems previously stated exist. Thus, assigning a multipoint (or “multicast”) address to each of the two terminals when a point to point call is established between two terminals is known. This solution enables, in particular, the mobility of terminals to be managed during cell changes, without introducing a major modification in the addressing policy. However, using two multipoint addresses makes the introduction or participation of a third-party terminal complex and ill-adapted.

One particular object of the invention is to mitigate the aforementioned disadvantages. For this purpose, the object of the invention is a method of establishing an initially point to point call between a first access point and a second access point through a network adapted to multipoint broadcasting, following a request to establish the call. The method according to the invention comprises the following steps:
(a) attribution of a multipoint address to the call;
(b) communication of the multipoint address to the first access point and to the second access point;
(c) registration of the first access point and the second access point to the multipoint address.

Throughout, the entire call, the first access point and the second access point, send all the media data of said call to the multipoint address. Third-party access points wishing to join the call may be registered with the multipoint address. When they no longer wish to be parties to the call, the first access point, or the second access point or third-party access points may be removed from the multipoint address.

In one embodiment, flows of media data from the call are filtered so as to not transmit to an access point data that it has itself transmitted.

Another object of the invention is a call server comprising a point to point call establishment module connected to a network adapted to the multipoint broadcasting of data. This network interconnects access points. The point to point call establishment, module comprises:
at least one multipoint address allocation module to allocate, following a request to establish a call between two access points, a multipoint address to the point to point call between the two access points;
at least one multipoint address broadcasting module to broadcast the multipoint address of the point to point call to at least the two access points.

In one embodiment, the call server comprises a call end management module to put an end to calls to the call when one of the two access points leaves the call.

In another embodiment, the call server comprises a

Call end management module to put an end to calls to the call when the two access points leave the call.

In another embodiment, the call server comprises a call end management module to put an end to calls to the call when the two access points and the third-party access points having joined the call leave the call.

Still another object of the invention is a communication system for implementing the method according to the invention for establishing a call between a first access point and a second access point. The communication system comprises at least one call server according to the invention and access points interconnected by a network adapted to the multipoint broadcasting of data. Each access point may in addition comprise means adapted for its removal from the multipoint address.

The particular advantages of the invention are that the invention allows the terminal mobility problem and the change of an individual call into a multiple call to be addressed simultaneously. The signaling effort necessary for such changes within the communication system is limited since the nature of the call is not affected by such changes. The invention also enables greater flexibility in call ending management to be achieved, and particularly enables this management to be better adapted to user needs.

Other characteristics and advantages of the invention will appear more clearly upon reading the following description with regard to the attached drawings that represent:

FIG. 1, a diagram of a mobile radiocommunication system according to the prior art;

FIG. 2, a block diagram of a method according to the invention for establishing a point to point call;

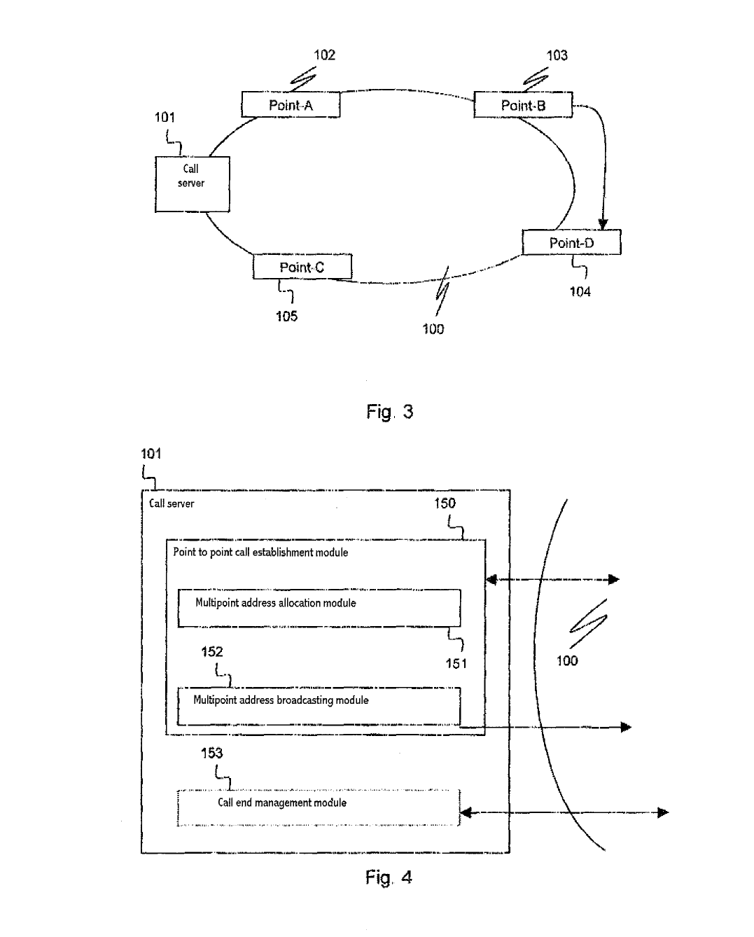

FIG. 3, a diagram of a communication system adapted to establishing point to point calls;

FIG. 4, a diagram of a call server according to the invention.

FIG. 2 illustrates, in a block diagram, a method according to the invention for establishing a point to point call between a first access point and a second access point. An access point may be connected, physically and/or logically, to one or more parties including, in particular, a terminal (for example a mobile telephone), recording devices, relays, communication stations, or any other device intervening in the establishment of a call such as, for example, a call server. Each access point and each party may be addressed by one or more point to point addresses.

In a first step 10 of the method according to the invention, the first access point requests the establishment of a call coming from the second access point. Therefore, the call request is initially a point to point call request, that is to say again, a call request between two access points. Following the present request, mechanisms that are usual and well-known to the person skilled in the art for establishing a call are implemented. Also, the flows of signals useful for establishing such a call are not necessarily different from the signal flows employed in methods according to the prior art. In particular, flows of signals conveyed between the first access point and the second access point may be exchanged by using point to point addresses corresponding to each access point.

Then in a second step 20 of the method according to the invention, a unique ADR_M_A multipoint address is attributed to the call established at the end of the first step 10. More precisely, the ADR_M_A multipoint address is the address that will be employed particularly by the first, and the second access points to broadcast media data flows from the call. Thus, unlike methods according to the prior art, a unique ADR_M_A multipoint address is attributed to each call. The ADR_M_A multipoint address may be a dynamically attributed address, or even be a determined or predetermined address, as needed. The ADR_M_A multipoint address is allocated for the entire call duration. Consequently, the ADR_M_A multipoint address may be used again later, after the end of the call, for a new call.

In a step 30 of the method according to the invention, the ADR_M_A multipoint address is communicated to the first access point and to the second access point. Thus, the ADR_M_A multipoint address or data allowing the ADR_M_A multipoint address to be determined may be sent through the flow of signals or other data flows to the first, access point and to the second access point, as well as optionally to any interested third-party access point.

In a step 40 of the method according to the invention, the first access point and the second access point are registered to the ADR_M_A multipoint address. A multipoint (more generally described by the term “multicast”) address allows a set of data to be sent to a group of recipients. An access point, wishing to receive data addressed to a multipoint address must consequently be registered with said multipoint address. The registration may be requested by the interested access point or by any other device intervening in establishing the call, to the routing means. In addition, an access point no longer wishing to receive data addressed to a multipoint address must be removed from said multipoint address. The removal may be requested by the interested access point or by any other device intervening in establishing the call, to the routing means. Therefore, the access points wishing to receive media data flows from the call must be registered, either upon their request or upon request of another device intervening in establishing the call, to the ADR_M_A multipoint address. The first access point and the second access point are registered with the ADR_M_A multipoint address. When the first access point or the second access point wishes to leave the call, they are removed, at their request or that of another device intervening in establishing the call, from the ADR_M_A multipoint address.

Once the different steps of the method according to the invention are implemented, all of the media data flows from the call are sent to the ADR_M_A multipoint address for the entire duration of the call. In particular, data flows relative to the voice are transmitted by the access points to the ADR_M_A multipoint address. All the access points registered with the ADR_M_A multipoint address consequently receive said media data flows. Following the establishment of the call, the first access point and the second access point therefore receive said media data flows. However, it may be desirable that the media data flows transmitted by an access point registered with the multipoint address are not received by said access point. Therefore, the media data flows may be filtered so as to not transmit to an access point data that it has itself transmitted. A filter having as a criterion the point to point address of the access point that had transmitted data to the ADR_M_A multipoint address, or all other information allowing said access point to be identified, may be applied. This filtering. May be performed by the routing means in charge of routing packets to said multipoint address.

During the call, at any time, third-party access points may be registered, at their request or upon request of another device intervening in establishing the call, to the ADR_M_A multipoint address. Third-party access points may, for example, acquire knowledge of said ADR_M_A multipoint address following their call establishment request and registering themselves. The third-party access points may also be registered, for example, by the device that had processed the call establishment.

After having joined the ADR_M_A multipoint address, the third-party access points receive all media data flows from the call. In addition, during the call, at any time, access points may request their removal from the ADR_M_A multipoint address to stop receiving all of the media data flows from the call. In addition, during the call, the devices having processed the call establishment may request that the ADR_M_A multipoint address be removed from one or more access points.

FIG. 3 illustrates, in a diagram, a communication system according to the invention adapted to establishing point to point calls. Elements that have already been referenced on other figures bear the same references. The communication system according to the invention is particularly adapted to implementing the method according to the invention for establishing a point to point, call. The communication system according to the invention comprises a network 100 adapted for broadcasting multipoint data. Network 100 may, for example, be a packet network. In particular, network 100 may transport packets conforming to the Internet Protocol, more commonly designated by the acronym “IP”. In the context of a network 100 of packets conforming to the Internet Protocol adapted to multipoint data broadcasting, such a network is generally designated by the term “multicast”. In particular, network 100 comprises routing means, for example routers, in charge of routing packets to a multipoint address. The routing means of network 100 particularly manage registration requests and removals in and from multipoint addresses. In the example illustrated by FIG. 3, network 100 comprises an access point A 102, an access point B 103, an access point C 105 and an access point D 104. An access point allows a terminal to access network 100, that is to say in particular to receive and send data via network 100 to and from other access points belonging to the network. The communication system according to the invention comprises at least one call server 101 according to the invention. Call server 101 according to the invention is particularly adapted to implementing steps 10, 20 and 30 of the method

According to the invention for establishing a point to point call. In addition, call server 101 according to the invention may be redundant. Several call servers 101 may also be distributed within the communication system according to the invention. With reference to FIG. 4, the call server 101 according to the invention comprises a module for establishing a point to point call 150. The point to point call establishment, module 150 is connected to network 100 and may consequently receive data via network 100, particularly transmitted by another call server 101 or by network 100 access points. The data received are, for example, requests for establishing a point to point call. Consequently, the point, to point call establishment module 150 may also transmit information via network 100, particularly to another call server 101 or even to access points. Data transmitted are, for example, signal data relative to establishing a point to point call. The point to point call establishment module 150 particularly allows the call establishment to be run and managed between access points 102, 103, 104, 105 of network 100. The point to point call establishment module 150 comprises a multipoint address allocation module 151 allowing a multipoint address to be allocated to a point to point call. The point to point call establishment module 150 comprises a multipoint address broadcasting module 152 allowing the multipoint address of the point to point call to be broadcast via network 100 at least to the initially affected access points, and possibly to the other call server 101, for example, or any other device that needs to know said multipoint address. The call server 101 may optionally comprise a call end management module 153 allowing it, on its own initiative, to put an end to calls.

When a first terminal from access point A 102 wishes to establish a first call via network 100 to a second terminal accessible from access point B 103, access point A 102 requests the establishment of the first call to call server 101. The multipoint address allocation module 151 of call server 101 then allocates an ADR_M_{—}1 multipoint address to the first call. The ADR_M_{—}1 multipoint address is then transmitted by the multipoint address broadcasting module 152 to access point A 102 and to access point B 103 via network 100. Each access point may comprise means enabling them to request their registration and optionally their removal in and from a multipoint address. Therefore access point A 102 and access point B 103 may be registered with the ADR_M_{—}1 multipoint address. In another embodiment, point, to point call establishment module 150 may request the registration of access point A 102 and access point B 103 with the ADR_M_{—}1 multipoint address. Then, for the entire call duration, access point. A 102 and access point B 103 send media data flows from the first call to the ADR_M_{—}1 multipoint address. By way of example, when a third terminal from access point C 105 wishes to join the first call, access point C 105 may then be registered with the ADR_M_{—}1 multipoint address. In another embodiment, the point to point call establishment module 150 may request the registration of access point C 105 with ADR_M_{—}1 multipoint address. In any case, the ADR_M_{—}1 multipoint address may, for example, be communicated by call server 101 to access point. C 105 when this latter formulates its call establishment request.

Thus, as flows of media data from the first call are sent to all access points registered to the ADR_M_{—}1 multipoint address, access point. C 105 will consequently receive flows of media data from the first call until access point C 105 is removed from the ADR_M_{—}1 multipoint address or until the call end management module 153 requests its removal. The communication system according to the invention therefore easily allows third-party access points to participate in a call initially established between two access points. In the case where the second terminal is displaced, after establishment of the first call, from access point B 103 to access point D 104 (which may occur, for example, when a terminal changes a cell in a radiocommunication network), access point D 104 is registered with the ADR_M_{—}1 multipoint address while access point. B is removed from the ADR_M_{—}1 multipoint address, once the transition procedure (“Hand-over”) is terminated. Seen from the second terminal, the transition between access point B 103 and access point D 104 may be transparent.

When call server 101 is equipped with one, the call end management module 153 may put an end to the first call, in various cases at its own initiative. The choice of the behavior of call end management module 153 is principally dictated by the type of call and by the operational needs of the system users. For example, when one of the two access points having initiated the first call leaves the call, the call end management module 153 may decide to put an end to the first call. The call end management module 153 may only decide to put an end to the first call when the two access points having initiated the call leave the call. The call end management module 153 may also decide to put an end to the first call when all parties to the first call have left the call.

According to one implementation, call server 101 may be a dedicated calculator connected to network 100 or even a computer connected to network 100. Call server 101 may comprise one or more point to point call establishment module or modules 150. The point to point call establishment module 150 as well as the multipoint address allocation module 151, the multipoint address broadcasting module 152, and the call end management module 153 may be electronic cards comprising the logic necessary for implementing the different functions or may even be computer programs comprising the necessary instructions for implementing the different functions.

1. A method for establishing a call that is initially point to point between a first access point and a second access point, through a network adapted to multipoint broadcasting, following a request to establish the call, wherein the method comprises the following steps:
(a) attributing a multipoint address (ADR_M_A) to the call;
(b) communicating the multipoint address (ADR_M_A) to the first access point and to the second access point; and
(c) registering the first access point and the second access point with the multipoint address (ADR_M_A);
wherein during the entire duration of the call, the first access point and the second access point send of the media data from said call to the multipoint address (ADR_M_A).

2. The method according to claim 1 wherein third-party access points wishing to join the call are registered with the multipoint address (ADR_M_A).

3. The method according to claim 2 comprising removing the first access point or the second access point or the third-party access points, when they no longer wish to be parties to the call, from the multipoint address (ADR_M_A).

4. The method according to claim 1 comprising filtering the media data flows from the call so as to not transmit to an access point data that it has itself transmitted.

5. A call server comprising a point to point call establishment module connected to a network adapted for multipoint data broadcasting, said network interconnecting access points wherein the point to point call establishment module comprises:
at least one multipoint address allocation module to allocate, following a request to establish a call between two access points, a multipoint address to the point to point call between the two access points; and
at least one multipoint address broadcasting module to broadcast the multipoint address of the point to point call to at least the two access points.

6. The call server according to claim 5 wherein the server comprises a call end management module to put an end to calls to the call when one of the two access points leaves the call.

7. The call server according to claim 5 wherein the server comprises a call end management module to put an end to calls to the call when the two access points leave the call.

8. The call server according to claim 5 wherein the server comprises a call end management module to put an end to calls to the call when the two access points and the third-party access points having joined the call leave the call.

9. A communication system, said communication system comprising at least one call server according to claim 5 and access points interconnected by a network adapted to the multipoint broadcasting of data, the communication system for establishing a call that is initially point to point between a first access point of the access points and a second access point of the access points, through the network, the network being adapted to multipoint broadcasting, the system, following a request to establish the call:
(a) attributing a multipoint address (ADR_M_A) to the call;
(b) communicating the multipoint address (ADR_M_A) to the first access point and to the second access point; and
(c) registering the first access point and the second access point with the multipoint address (ADR_M_A);
wherein during the entire duration of the call, the first access point and the second access point send all of the media data from said call to the multipoint address (ADR_M_A).

10. The communication system according to claim 9, wherein each access point comprises means adapted for its removal from the multipoint address (ADR_M_{—}1).
